(19) United States
(12) Patent Application Publication
(10) Pub. No.: US 2006/0117304 A1
(43) Pub. Date: Jun. 1, 2006

(54) Method and system for localizing a package

(75) Inventors: Demitri R. Anastassopoulos, Redmond, WA (US); David C. Brombaugh, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/996,978

(22) Filed: Nov. 23, 2004

(51) Int. Cl. G06F 9/45

(52) U.S. Cl. 717/136

(57) ABSTRACT

A localization tool is arranged to automatically localize a raw package for a target language, country or geographic region. The raw package is an executable binary stored in a specific location identified in a file system. The raw package includes data that identifies localization information. The localization tool uses the localization information to create a list of files to be localized in the target language, identify any strings to replace within each file, locate the files to be localized in the file system where the raw package is stored, and create any other parameters and functions required to localize the raw package. The raw package is localized by applying the target language, country or geographic region specific information to the files to be localized. The localized package is then stored in a target directory within the file system.

### BACKGROUND OF THE INVENTION

Computer hardware and software vendors seeking to expand their market internationally are required to localize the related operating system and software applications to accommodate the language, laws, customs and culture of individual target markets. Different cultures and countries have different rules for punctuation, grammar, currency measures and conversions, number formats and other local idiosyncrasies. For example, the Chinese language includes thousands of characters requiring a double byte character set to represent a single character, whereas the character set used in the United States includes less than 256 characters each of which can be accommodated by a single 8 bit byte.

Localization is a labor intensive process that requires the employ of both translators and software designers. The complexity of the localization process increases the likelihood of error such that time-consuming testing procedures are required. Customers demand that the localization of different releases of the same product remain consistent, and that new releases and user updates are available at the same time as they are announced in the United States.

### SUMMARY OF THE INVENTION

A localization tool is arranged to automatically localize a raw package for a target language, country or geographic region. The raw package is an executable binary stored in a specific location identified in a file system. The raw package includes data that identifies localization information. The localization information may include a list of language specific character strings associated with the raw package, a list of target languages that are supported by the raw package, and special cases associated with a target language, country, or geographic region. The raw package may be an operating system, a software application, a file, a program patch, a user update, or other types of documentation such as help files.

The localization tool parses source files in the location of the file system where the raw package is stored to extract the corresponding localization information. The localization tool uses the localization information to create a list of files to be localized in the target language, identify any strings to replace within each file, locate the files to be localized in the file system where the raw package is stored, and create any other parameters and functions required to localize the raw package. The localization tool determines the target language, any target country specific information, and any geographic region specific information from the localization information.

The raw package, the corresponding localization information, and the list of files to be localized are used to create a task list. Items in the task list are performed to complete localization of the raw package. The raw package is localized by applying the target language, country or geographic region specific information to the files to be localized. For example, language specific portions of the raw package are replaced with corresponding target language character strings from a localized string database to produce the localized package. The localized package is then stored in a target directory within the file system.

### BRIEF DESCRIPTION OF THE DRAWINGS

FIG. 1 illustrates a computing device that may be used according to an example embodiment of the present invention.

FIG. 2 illustrates a block diagram of a system for localizing a package, in accordance with the present invention.

FIG. 3 is an operational flow diagram illustrating a process for localizing a package, in accordance with the present invention.

### DETAILED DESCRIPTION OF THE PREFERRED EMBODIMENT

A localization tool is arranged to automatically localize a raw package for a target language, country or geographic region. The raw package is an executable binary stored in a specific location identified in a file system. The raw package includes data that identifies localization information. The localization information may include a list of language specific character strings associated with the raw package, a list of target languages that are supported by the raw package, and special cases associated with a target language, country, or geographic region. The localization tool uses the localization information to create a list of files to be localized in the target language, identify any strings to replace within each file, locate the files to be localized in the file system where the raw package is stored, and create any other parameters and functions required to localize the raw package. The raw package is localized by applying the target language, country or geographic region specific information to the files to be localized. The localized package is then stored in a target directory within the file system.

Illustrative Operating Environment

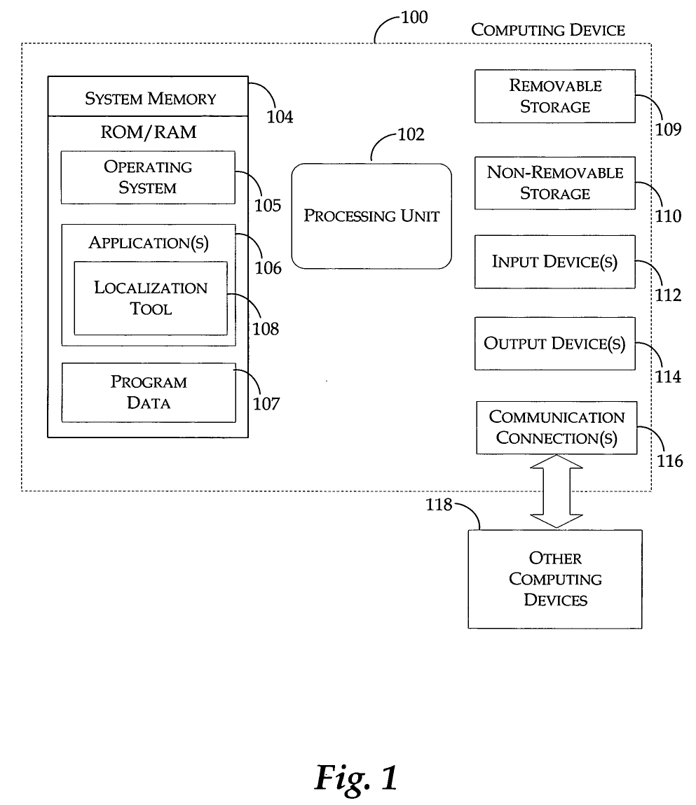

With reference to FIG. 1, one example system for implementing the invention includes a computing device, such as computing device 100. Computing device 100 may be configured as a client, a server, a mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. A localization tool 108, which is described in detail below, is implemented within applications 106.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Localization Tool

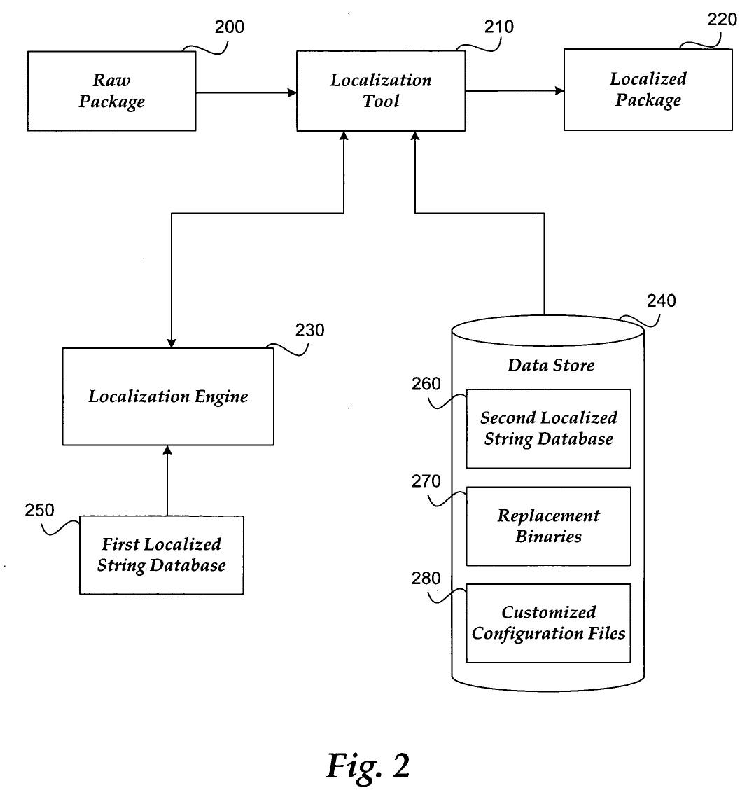

FIG. 2 illustrates a block diagram of a system for localizing a package. The system includes raw package 200, localization tool 210, localized package 220, localization engine 230, data store 240, and first localized string database 250. Raw package 200 is submitted to localization tool 210 to produce localized package 220. Localization engine 230 and data store 240 are coupled to localization tool 210. First localized string database 250 is coupled to localization engine 230.

Data store 240 includes second localized string database 260, replacement binaries 270, and customized configuration files 280. Localized string databases 250, 260 each include a set of target language strings that are stored in a specific location within raw package 200. The set of strings may be created during product development. The set of strings may include translation information associated with the language of raw package 200 and the target language. Replacement binaries 270 may include objects, executables and linkable programs. Raw package 200 can be any executable binary stored in a specific file system (e.g., a file directory structure). Raw package 200 may be an operating system, a software application, a file, a program patch, a user update, or other types of documentation such as help files. Raw package 200 includes information in a specific language that can be localized into a target language. For example, raw package 200 may be an English version of a software application program. A software manufacturer may desire to sell the application in France. Rather than performing the French translation manually, the language specific portions of the application are automatically translated using localization tool 210 and localization engine 230 to produce localized package 220. The language specific portions of a package may include text strings, currency measures and conversions, punctuation, grammar, number formats, and the like. Raw package 200 includes data that identifies localization information. In one example, raw package 200 includes an initialization file that defines target languages. In another example, raw package 200 identifies special country or geographic region requirements that may require inclusion, removal, or replacement of certain binaries associated with the target country or geographic region. In still another example, an end user licensing agreement (EULA) is replaced in raw package 200 based on the target country.

Special cases may exist for certain target languages, countries, or geographic regions within a country. When localization tool 220 encounters a special case, the list of files to localize is modified such that raw package 200 is localized for the special case. For example, Greek, Japanese, and Chinese characters may be represented using Unicode or double byte character set (DBCS) rather than the American Standard Code for Information Interchange (ASCII). Both Unicode and DBCS use two bytes for representing characters as integers. Unlike ASCII, Unicode and DBCS use 16 bits per character, which means that more than 65,000 unique characters may be represented. When a Unicode or DBCS file is used in an ASCII operating system, each word has extra space after each character because the operating system cannot properly process the file. Since the file may only be properly displayed in a Unicode or DBCS operating system, localization tool 210 determines whether to localize the file by replacing the file such that the new character set may be used with the Unicode or DBCS character set.

Localization tool 210 receives raw package 200. Localization tool 210 parses source files from raw package 200 to extract the corresponding localization information. For example, localization tool 210 creates a list of files to be localized in the target language, identifies the strings to replace within each file, locates the files in raw package 200 (e.g., stored in the file directory structure), and creates any other parameters and functions required by localization engine 230 to perform the localization of raw package 200. In one embodiment, raw package 200 is localized using replacement binaries 260 to remove, replace, and/or add binaries based on the target language, country, or geographic region. In another embodiment, raw package 200 is localized using customized configuration files 270. Localization tool 210 may submit a portion of raw package 200 and the corresponding localization information to localization engine 230 for replacing strings in raw package 200 with strings from first localized database 250.

Localization tool 210 creates a task list from the list of files to be localized. Items in the task list are processed to complete localization. For example, step one may be to replace text strings from second localized string database 260 at a location identified in the configuration file for the target language. Step two may be to replace binaries with replacement binaries 270 based on a country code associated with the target language. Step three may be to add additional text and/or binaries based on the target language, country or geographic region.

Localization engine 230 applies target language information (including the set of localized strings from first localized string database 250 to replace the corresponding strings in the source file) to raw package 200 to create localized package 220. Localized package 220 is returned to localization tool 210. Localization tool 210 stores localized package 220 in a target directory within the file system (e.g., a file directory structure). The target directory may include other packages that have been localized for the target language, country or geographic region.

In one embodiment, one package includes multiple files that require localization. A file is localized and checked to ensure proper operation. The process is repeated until all the files are localized for the target language, country, or geographic region. The process continues for each additional target language, country or geographic region. Each localized package may be stored in a separate area of the target directory in the file system.

In one embodiment, localization may not be necessary because raw package 200 does not include strings specific to any particular language (i.e., the file includes only code). Thus, raw package 200 is copied to the target directory without processing by localization tool 210. In another embodiment, raw package 200 requires localization in some languages, but not in others. Thus, either the localized package or the raw package is stored in the target directory. In yet another embodiment, raw package 200 is localized by replacing binaries in the raw package with binaries associated with the target language, country, or geographic region.

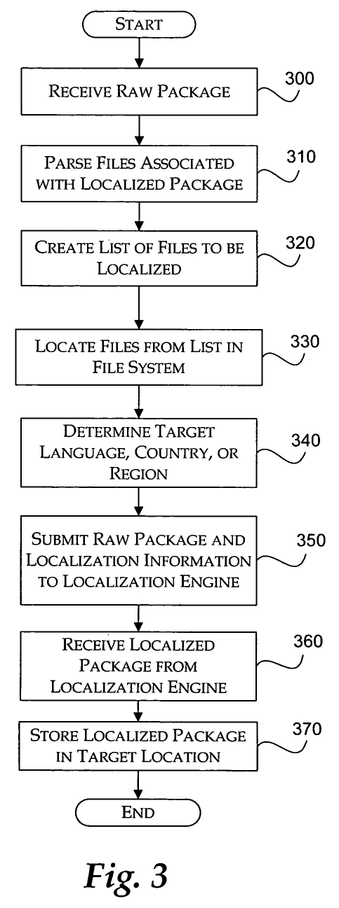

FIG. 3 is an operational flow diagram illustrating a process for localizing a binary. The process begins at a start block where a raw package is to be localized for a target language, country or geographic region. In one embodiment, the raw package is an executable binary stored in a specific location identified in the file system.

Moving to block 300, the localization tool receives the raw package. The raw package is associated with localization files that are stored in the same target location within the file system as the raw package. The localization files include localization information associated with the raw package. For example, the localization information includes a list of language specific character strings associated with the raw package, a list of target languages that are supported by the raw package, and special cases associated with a target language, country, or geographic region.

Proceeding to block 310, the localization tool parses the localization files associated with the raw package to obtain the corresponding localization information. Advancing to block 320, the localization tool uses the localization information to create a list of files to be localized. Continuing to block 330, the localization tool locates the files to be localized in the file system where the raw package is stored. Transitioning to block 340, the localization tool determines the target language, target country specific information, or target geographic region specific information from the localization information.

Moving to block 350, the localization tool processes the raw package using the corresponding localization information. The localization tool creates a task list from the list of files to be localized. Items in the task list are processed to complete localization. The localization tool applies target language, country or geographic region specific information to the files to be localized to produce the localized package. In one embodiment, the localization engine replaces language specific character strings in the raw package with the corresponding character strings in the target language. The target language character strings are stored in a localized string database. In another embodiment, a EULA in the raw package is replaced with a localized EULA. In yet another embodiment, text in the raw package is eliminated or new text is added to the raw package. In still another embodiment, an existing binary in the raw package is replaced or eliminated, or a new binary is added to the raw package.

Proceeding to block 360, the localization tool receives the localized package from the localization engine. Advancing to block 370, the localization tool stores the localized package in a target location (e.g., directory) within the file system. The target location may include other packages which have been localized for the target language, country or geographic region.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for localization of a raw package, comprising:
identifying source files to localize, wherein the source files are associated with the raw package;
identifying indicia associated with the localization of the raw package into localized packages;
processing the identified source files for each of the localized packages according to the indicia associated with each of the localized packages; and
creating the localized packages from the processed source files, wherein each localized package corresponds to a localized version of the raw package associated with the indicia associated with each localized package.

2. The computer-implemented method of claim 1, wherein the indicia corresponds to at least one of: a designated language, a designated country, and a designated geographic region.

3. The computer-implemented method of claim 1, wherein the raw package comprises at least one of: an executable binary, an operating system, a software application program, a file, a program patch, and a user update.

4. The computer-implemented method of claim 1, further comprising parsing the identified source files to extract localization information.

5. The computer-implemented method of claim 4, wherein the localization information comprises at least one of: a target language, a list of language specific character strings, and special requirements for a target language, country, and geographic region.

6. The computer-implemented method of claim 5, wherein the special requirements for the target language, country, and geographic region further comprises at least one of: removing text strings from the raw package, removing binaries from the raw package, replacing text strings in the raw package, replacing binaries in the raw package, adding text strings to the raw package, and adding binaries to the raw package.

7. The computer-implemented method of claim 1, wherein identifying source files to localize further comprises locating the identified source files within the raw package.

8. The computer-implemented method of claim 1, further comprising creating a task list from the identified source files, wherein the task list comprises items to be processed to create the localized packages.

9. The computer-implemented method of claim 1, further comprising retrieving the raw package from a target directory in a file system.

10. The computer-implemented method of claim 1, further comprising storing the localized package in a target directory in a file system.

11. A system for localizing a raw package, comprising:
a computer system having a memory, wherein the raw package is loaded in the memory; and
a localization tool loaded in the memory, wherein the localization tool is arranged to:
identify source files to localize, wherein the source files are associated with the raw package;
create a task list based on the identified source files;
identify indicia associated with the localization of the raw package into localized packages;
process the identified source files for each of the localized packages according to the indicia associated with each of the localized packages; and
create the localized packages from the processed source files and the task list, wherein each localized package corresponds to a localized version of the raw package associated with the indicia associated with each localized package.

12. The system of claim 11, wherein the indicia corresponds to at least one of: a designated language, a designated country, and a designated geographic region.

13. The system of claim 11, wherein the raw package comprises at least one of: an executable binary, an operating system, a software application program, a file, a program patch, and a user update.

14. The system of claim 11, wherein the localization tool is further arranged to parse the identified source files to extract localization information.

15. The system of claim 14, wherein the localization information comprises at least one of: a target language, a target country, a target geographic region, a list of language specific character strings, and special requirements for the target language, country, and geographic region.

16. The system of claim 15, wherein the special requirements for the target language, country, and geographic region further comprises at least one of: removing text strings from the raw package, removing binaries from the raw package, replacing text strings in the raw package, replacing binaries in the raw package, adding text strings to the raw package, and adding binaries to the raw package.

17. The system of claim 11, wherein the localization tool identifies source files to localize by locating the identified source files within the raw package.

18. The system of claim 11, wherein the task list comprises items to be processed to create the localized packages.

19. The system of claim 11, wherein the localization tool is further arranged to:
retrieve the raw package from a target directory in a file system; and
store the localized package in the target directory in the file system.

20. A computer-readable medium having computer-executable instructions for localizing a raw package, comprising:
identifying source files to localize, wherein the source files are associated with the raw package;
identifying indicia associated with the localization of the raw package into localized packages, wherein the indicia comprises at least one of: a target language, a target country, and a target geographic region;
processing the identified source files for each of the localized packages according to the indicia associated with each of the localized packages; and
creating the localized packages from the processed source files, wherein each localized package corresponds to a localized version of the raw package associated with the indicia associated with each localized package.

21. The computer-readable medium of claim 20, wherein the raw package comprises at least one of: an executable binary, an operating system, a software application program, a file, a program patch, and a user update.

22. The computer-readable medium of claim 20, further comprising parsing the identified source files to extract localization information.

23. The computer-readable medium of claim 22, wherein the localization information comprises at least one of: the target language, a list of language specific character strings, and special requirements for the target language, country, and geographic region.

24. The computer-readable medium of claim 23, wherein the special requirements for the target language, country, and geographic region further comprises at least one of: removing text strings from the raw package, removing binaries from the raw package, replacing text strings in the raw package, replacing binaries in the raw package, adding text strings to the raw package, and adding binaries to the raw package.

25. The computer-readable medium of claim 20, wherein identifying source files to localize further comprises locating the identified source files within the raw package.

26. The computer-readable medium of claim 20, further comprising creating a task list from the identified source files, wherein the task list comprises items to be processed to create the localized packages.

27. The computer-readable medium of claim 20, further comprising retrieving the raw package from a target directory in a file system.

28. The computer-readable medium of claim 20, further comprising storing the localized package in a target directory in a file system.
